(19) United States
(12) Patent Application Publication
(10) Pub. No.: US 2006/0187333 A1
(43) Pub. Date: Aug. 24, 2006

(54) Still image pickup device

(75) Inventors: Michio Kobayashi, Suwa (JP); Hiroyuki Yokoyama, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/360,916

(22) Filed: Feb. 23, 2006

(30) Foreign Application Priority Data
Feb. 24, 2005 (JP) 2005-048640

(51) Int. Cl. H04N 5/222

(52) U.S. Cl. 348/333.01

(57) ABSTRACT

An image pickup device includes: image pickup means that opposes correctly to a photographic subject, and forms and picks up an image of the same; display means that displays an image data picked up by the image pickup means; distance measuring means that measures a distance to the photographic subject to be picked up by the image pickup means; index display means that displays an index on the display means so as to be superimposed on the image data; angle of inclination measuring means that measures an angle of inclination of the image pickup means when it is inclined so as to align the index displayed by the index display means with a desired portion to be measured; and actual dimension calculating means that calculates actual dimensions of an image of the photographic subject on the basis of a measurement of the distance measuring means and a measurement of the angle of inclination measuring means.

### BACKGROUND

1. Technical Field

The present invention relates to an image pickup device for picking up an image of a digital camera, a video camera, and so on, which is configured to be able to measure dimensions of a photographic subject.

2. Related Art

As a dimension measuring device in the related art, a portable dimension measuring device including an acceleration sensor that detects acceleration, for example, in X, Y and Z directions, supported via a gyroscopic mechanism and outputs acceleration signals α1 to α3 in the three-dimensional direction according to a movement of a body case is known. The portable dimension measuring device is configured to integrate the acceleration signals α1 to α3 twice with integrating means to convert the same into integrated signals Lx, Ly and Lz that indicate amounts of movement per unit time, turn a measurement start/end switch ON while the body case is moved from an arbitrary measurement start position to a measurement end position, sample the integrated signals Lx, Ly and Lz by a CPU at predetermined cycles during a period when the measurement start/end switch is ON, and calculate an amount of linear movement of the body case sequentially on the basis of the sampled data, so that an optimal value is calculated as a linear distance between the measurement start position and the measurement end position (see JP-A-8-114439, P. 1, FIG. 1).

In an example of the related art shown above, dimensions of a subject to be measured can be measured by moving the portable dimension measuring device along the subject to be measured. However, there is an unsolved problem such that when the subject to be measured is a large substance such as a building, it is impossible to move the portable dimension measuring device along the building and hence it cannot be applied to a long and large subject to be measured.

### SUMMARY

An advantage of some aspects of the invention is to provide an image pickup device that can measure dimensions or surface areas of a substance such as a long and large building.

An image pickup device according to a first aspect of the invention includes image pickup means that opposes correctly to a photographic subject, and forms and picks up an image of the same; display means that displays an image data picked up by the image pickup means; distance measuring means that measures a distance to the photographic subject to be picked up by the image pickup means; index display means that displays an index on the display means so as to be superimposed on the image data; angle of inclination measuring means that measures an angle of inclination of the image pickup means when it is inclined to align the index displayed by the index display means with a desired portion to be measured; and actual dimension calculating means that calculates actual dimensions of an image of the photographic subject on the basis of a measurement of the distance measuring means and a measurement of the angle of inclination measuring means.

According to the first aspect of the invention, the image pickup device picks up the image of the photographic subject with the image pickup means in a state of opposing correctly to the photographic subject, measures the distance to the photographic subject at this time with the distance measuring means, and measures the angle of inclination of the image pickup means at this time with the angle of inclination measuring means by moving the index displayed on the display means by the, index display means from a predetermined start position to a predetermined end position of the photographic subject, so that the actual dimensions between the desired positions of the photographic subject can be calculated on the basis of the distance to the photographic subject measured with the distance measuring means and the angle of inclination measured with the angle of inclination measuring means with the actual dimension calculating means. Therefore, the actual dimensions can be calculated in a simple operation such as aligning the index to the position between the point to be measured while picking up the image of the photographic subject.

An image pickup device according to a second aspect of the invention includes image pickup means that opposes correctly to a photographic subject, and forms and picks up an image of the same; display means that displays an image data picked up by the image pickup means; distance measuring means that measures a distance to the photographic subject to be picked up by the image pickup means; index display means that displays an index on the display means so as to be superimposed on the image data; angle of inclination measuring means that measures an angle of inclination of the image pickup means when it is inclined to align the index displayed by the index display means with a desired portion to be measured; and actual surface area calculating means that calculates actual surface area of an image of the photographic subject on the basis of a measurement of the distance measuring means and a measurement of the angle of inclination measuring means.

Preferably in the second aspect of the invention, a circumferential length can be measured, and the surface area of the photographic subject can be calculated by moving the index displayed by the index display means along a contour of the photographic subject.

In the image pickup device according to a third aspect of the invention, the index display means is configured to display a cross cursor on the display means so as to be superimposed on the image data.

According to the third aspect of the invention, since the index is a cross cursor, and hence one of crossed lines can be fixed to be used as a guide, a linear movement of the index in the vertical direction and the horizontal direction can be achieved easily.

In the image pickup device according to a fourth aspect of the invention, the angle of inclination measuring means is a gyroscopic sensor for correcting camera shake.

In this arrangement, since the angle of inclination can be calculated using a gyroscopic sensor for correcting the camera shake, the dimensions or the surface area can be measured without providing an additional angle of inclination detecting means.

### BRIEF DESCRIPTION OF THE DRAWINGS

The invention will be described with reference to the accompanying drawings, wherein like numbers reference like elements.

FIG. 1 is a block diagram showing an embodiment in a case in which the invention, is applied to a digital camera.

FIG. 2 is a flowchart showing an example of a procedure of a dimension measuring process executed by a microcomputer shown in FIG. 1.

FIG. 3 is an explanatory drawing showing an imaging relation between a photographic subject and an image of the photographic subject.

FIG. 4 is an explanatory drawing showing a state of measurement of the photographic subject.

FIG. 5 is a flowchart showing another example of a procedure of the dimension measuring process executed by the microcomputer in FIG. 1.

### DESCRIPTION OF EXEMPLARY EMBODIMENTS

Referring now to the drawings, an embodiment of the invention will be described.

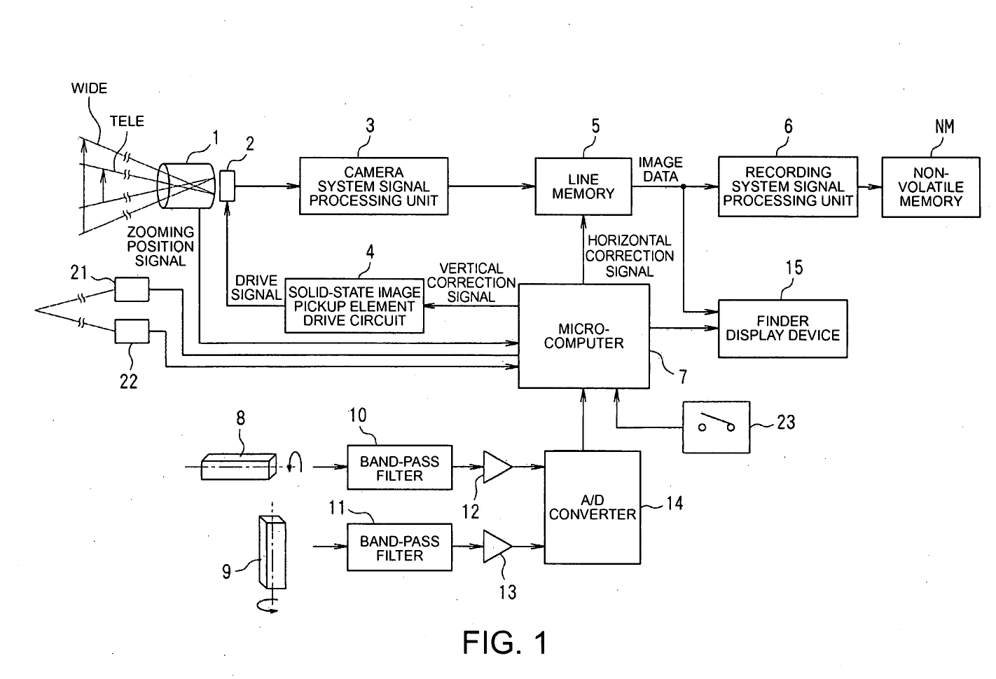

FIG. 1 is a block diagram showing an embodiment in which the invention is applied to a digital camera.

In the drawing, reference numeral 1 designates a zoom lens. An image of a photographic subject is formed on a solid-state image pickup element 2 provided on a downstream side thereof by the zoom lens 1. The solid-state image pickup element 2 performs photographic conversion according to a drive signal from a solid-state image pickup element drive circuit 4. An output of the photographic conversion is supplied to a camera system signal processing unit 3, where the output is applied with a sampling process and an AGC process, then is converted into digital data by an A/D conversion process, and then is applied with a γ correction process, an encoding process, and so on, and finally is supplied to a line memory 5. Here, the zoom lens 1 and the solid-state image pickup element 2 constitute image pickup means.

According to the embodiment, the solid-state image pickup element 2 having a pixel area larger than an effective area which is displayed actually on a display section in both horizontal and vertical directions is employed for correcting camera shake, and in order to absorb the camera shake according to an amount of the camera shake occurred, effective pixels from the solid-state image pickup element 2 are extracted by trimming by the solid-state image pickup element drive circuit 4 in the vertical direction, and effective pixels therefrom are extracted by trimming by the line memory 5 in the horizontal direction, so that a screen having an aspect ratio of 3:4 without blur is finally created.

When the effective pixels in the horizontal direction are extracted by trimming from the line memory 5 and a predetermined image data without blur is supplied to a display device 15 composed of a liquid crystal display, an organic EL display or the like and is outputted to a recording system signal processing unit 6, where JPEG conversion or the like is performed, and then is stored in a non-volatile memory NM composed of a DRAM, a SRAM or a flash memory.

In order to correct camera shake, vertical and horizontal angle sensors 8 and 9 composed of a gyroscopic sensor that detect the fact that a Corioli's force is generated in the vertical and horizontal directions of an enclosure are provided. Detection signals outputted from the vertical and horizontal angle sensors 8 and 9 are supplied to band-pass filters 10 and 11 to give a limitation to the bands thereof, are amplified in amplifiers 12 and 13, are converted into digital signals by an A/D converter 14, and then are supplied to a microcomputer 7 that controls the entirety of the digital camera.

Zooming position information from Wide to Tele is supplied from the zoom lens 1 to the microcomputer 7 as a zooming position signal, and the microcomputer 7 generates a horizontal camera-shake correction signal to be outputted to the line memory 5 on the basis of the zooming position signal, and also generates a vertical camera-shake correction signal to be supplied to the solid-state image pickup element drive circuit 4.

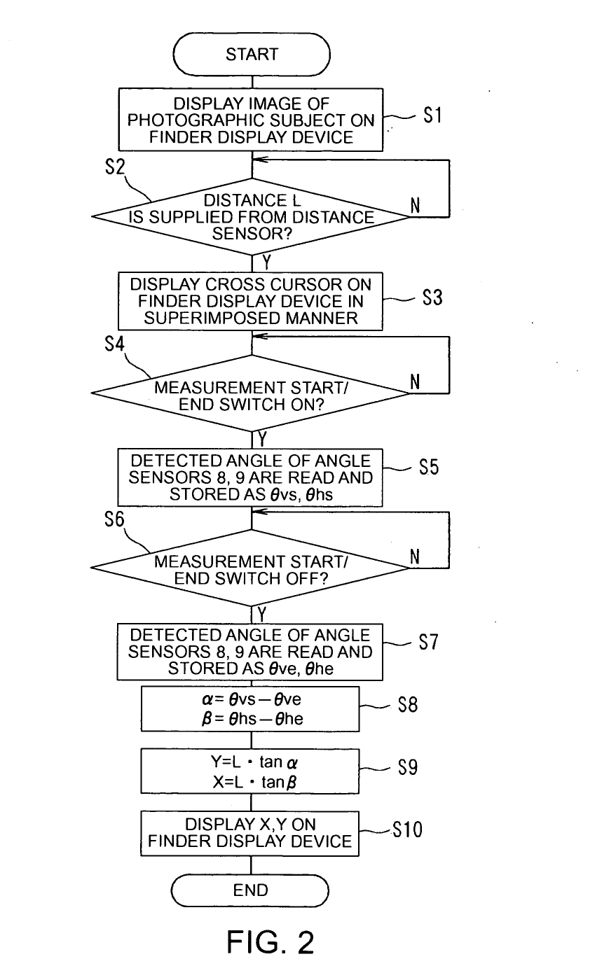

A distance sensor 22 for measuring a distance to a photographic subject by detecting an incident angle of a reflected light of an infrared ray emitted from an infrared ray emitting unit 21 from the photographic subject is connected to the microcomputer 7, and a measurement start/end switch 23 for setting start and end of measurement of dimensions is connected thereto. A photographic subject dimension measuring process shown in FIG. 2 is executed on the basis of a distance L measured by the distance sensor 22, angles of inclination θv and θh detected by the vertical and horizontal angle sensors 8 and 9, and a switch signal from the measurement start/end switch 23.

The photographic subject dimension measuring process is started, for example, when a menu display button is pressed to display a selection menu including various menu items such as the dimension measuring process on the display device 15 and the dimension measuring process is selected from these menus. Firstly, in Step S1, image data of a photographic subject imaged on the solid-state image pickup element 2 is stored in the line memory 5 via the camera system signal processing unit 3, and the image data is displayed on the finder display device 15.

Subsequently, the procedure goes to Step S2, where the zoom lens 1 is directed to the photographic subject to be measured and a desired image of the photographic subject is formed on the solid-state image pickup element 2. In this state, whether or not the distance L is supplied from the distance sensor 22 is determined by pressing a shutter button half a way down. When the distance L is not supplied, the procedure waits until it is supplied, and when the distance L is supplied, the procedure goes to Step S3.

In Step S3, a cross cursor that is crossed on an optical axis of the zoom lens is displayed on the image data of the photographic subject displayed on the finder display device 15 in a superimposed manner.

Then, the procedure goes to Step S4, where whether or not the measurement start/end switch 23 is turned to an ON state which indicates a measurement start point is determined. When the measurement start/end switch 23 is continuously in an OFF state, the procedure waits until it is changed into the ON state. When it is in the ON state, the procedure goes to Step S5, where angles of inclination θvs and θhs detected by the vertical angle sensor 8 and the horizontal angle sensor 9 at this time are read and stored. Subsequently, the procedure goes to Step S6, where whether or not the measurement start/end switch 23 is turned to the OFF state which indicates a measurement end point is determined. When it is continuously in the ON state, the procedure waits until it is changed into the OFF state. When it is turned into the OFF state, the procedure goes to Step S7, where angles of inclination θve and θhe detected by the vertical angle sensor 8 and the horizontal angle sensor 9 at this time are read. Then, the procedure goes to Step S8 where the angle of inclination θve when measurement is ended is subtracted from the angle of inclination θvs when measurement is started to obtain a vertical angle of inclination α, and the angle of inclination θhe when measurement is ended is subtracted from the angle of inclination θhs when measurement is started to obtain a horizontal angle of inclination β.

Subsequently, the procedure goes to Step S9, where calculations of the following expressions (1) and (2) are executed on the basis of the distance L detected by the distance sensor 22, the vertical angle of inclination α and the horizontal angle of inclination β , so that a vertical actual distance Y and a horizontal actual distance X are calculated. Then, the procedure goes to Step S10, where the calculated vertical actual distance Y and the horizontal actual distance X are displayed on the finder display device 15 to end the dimension measuring process.
Y=L·tan α (1)
X=L·tan β (2)

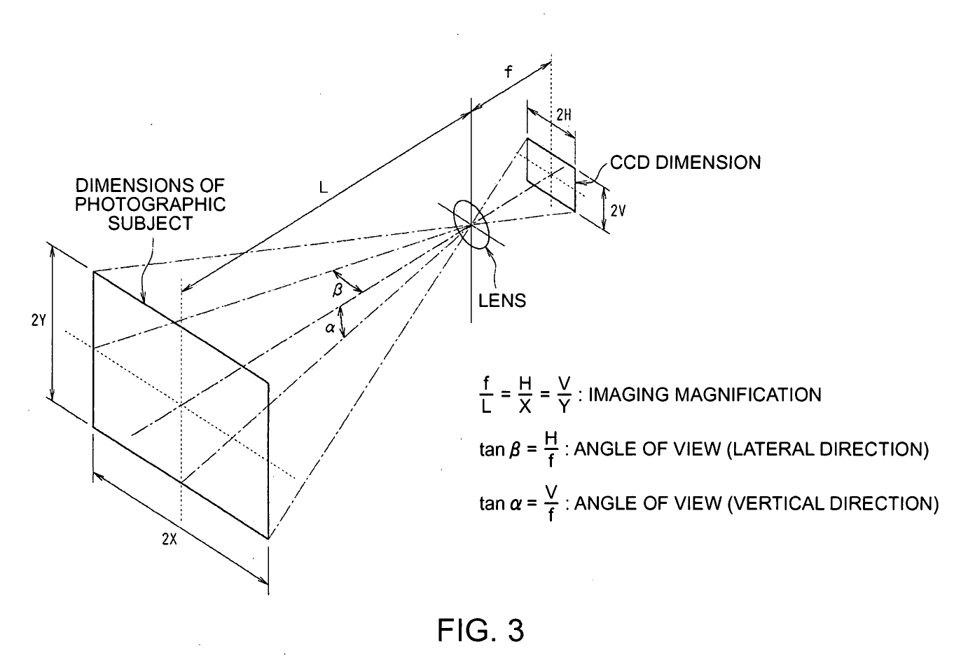

Here, the reason why the vertical actual distance Y and the horizontal actual distance X can be obtained from the expressions (1) and (2) shown above is as follows. As shown in FIG. 3, it is assumed that the photographic subject is a square frame in order to simplify explanation. Assuming that L represents a distance from the zoom lens 1 and the photographic subject, and f represents a distance between the zoom lens 1 and an imaging surface of the solid-state image pickup element 2, that is a focal distance, a magnification of an image of the square frame formed on the solid-sate image pickup element 2 through the zoom lens 1 can be expressed by an expression (3).
f/L=H/X=V/Y (3)

An angle of view in the vertical direction, that is, an angle of inclination tan α and an angle of view in the horizontal direction, that is an angle of inclination tan β are expressed by the following expressions (4) and (5).
tan α=V/f (4)
tan β=H/f (5)

Therefore, when the angles of inclination tan α and tan β and the distance L can be measured, V=f·tan α, H=f·tan β can be obtained from the expressions (4) and (5). By substituting these values for the above-described expression (3), the following expressions are obtained.
Y=L·V/f=L·f·tan α/f=L·tan α
X=L·H/f=L·f·tan β/f=L·tan β

Therefore, the vertical actual distance Y and the horizontal actual distance X can be calculated.

In the process shown in FIG. 2, the process in Step S3 corresponds to index display means, and the process from Step S4 to Step S10 correspond to actual dimension calculating means.

Subsequently, an operation of the above-described embodiment will be described.

If a dimension measuring menu item is not selected from the selection menu, and the camera is set to a normal photographing mode, a current image of the photographic subject formed on the solid-state image pickup element 2 is read and applied with signal processing in the camera system signal processing unit 3, which is overwritten constantly and is stored in the line memory 5. Therefore, the image data of the photographic subject stored in the line memory 5 is supplied to the finder display device 15 and is displayed in the finder.

In this state, when the distance L is measured by pushing the shutter button half a way down, thereby bringing the photographic subject into focus by an automatic focusing function, and in this state, the shutter button is further pushed downward, the image data formed on the solid-state image pickup element 2 at this time is read in sequence by the solid-state image pickup element drive circuit 4, is applied with a predetermined signal processing by the camera system signal processing unit 3, and then is stored in the line memory 5.

At this time, a state of camera shake is detected by the vertical angle sensor 8 and the horizontal angle sensor 9, and the detected signals are band-limited by the band-pass filters 10 and 11, are amplified by the amplifiers 12 and 13, are converted into digital signals by the A/D converter 14, and then are supplied to the microcomputer 7. Therefore, blur correction process is performed by the microcomputer 7, and the vertical camera-shake correction signal is outputted to the solid-state image pickup element drive circuit 4, whereby the effective pixels of the solid-state image pickup element 2 are extracted by trimming so as to absorb the camera shake in the drive circuit 4, and as regards the horizontal direction, the horizontal camera-shake correction signal is outputted to the line memory 5, whereby the effective pixels in the horizontal direction are extracted from the line memory 5 by trimming, so that the image data without blur is formed, which is applied with signal processing such as JPEG or the like in the recording system signal processing unit 6, and is stored in the non-volatile memory NM.

When the selection menu is displayed on the finder display device 15 from this normal photographing mode and a dimension measuring mode is selected from the selection menu, the dimension measuring process shown in FIG. 2 is executed.

At this time, a user causes the photographic subject to be displayed at a center of the finder display device 15 in a state of being opposed to the photographic. subject to be measured, and in this state, and presses the shutter button half a way down to measure the distance L from the photographic subject by the distance sensor 22.

When the measurement of the distance L is completed, a cross cursor is displayed on the finder display device 15 with an intersecting point of a vertical line Lv and a horizontal line Lh located at a center position of the finder display device 15. Then, when the measurement start/end switch 23 is turned ON in a state in which the intersecting point of the displayed cross cursor is aligned with a position where the user wants to start measurement of the distance, the detected angles detected by the vertical angle sensor 8 and the horizontal angle sensor 9 at this time are read and stored as measurement start angles θvs and θhs.

Subsequently, when the measurement start/end switch 23 is turned OFF with the intersecting point of the cross cursor aligned with a position where the user wants to end measurement, the detected angles detected by the vertical angle sensor 8 and the horizontal angle sensor 9 are read as measurement end angles θve and θhe.

Subsequently, by subtracting the measurement end angles θve and θhe from the measurement start angles θvs and θhs both in the vertical direction and in the horizontal direction, the vertical and horizontal angles of inclination α and β from the measurement start point to the measurement end point are obtained. Then, by substituting the angles of inclination α and β and the distance L for those values in the expressions (1) and (2), the vertical actual distance Y and horizontal actual distance X can be calculated.

Since the calculated vertical actual distance Y and the horizontal actual distance X are displayed on the finder display device 15, the distance between the positions to be measured can be figured out by viewing the vertical actual distance Y and the horizontal actual distance X displayed thereon.

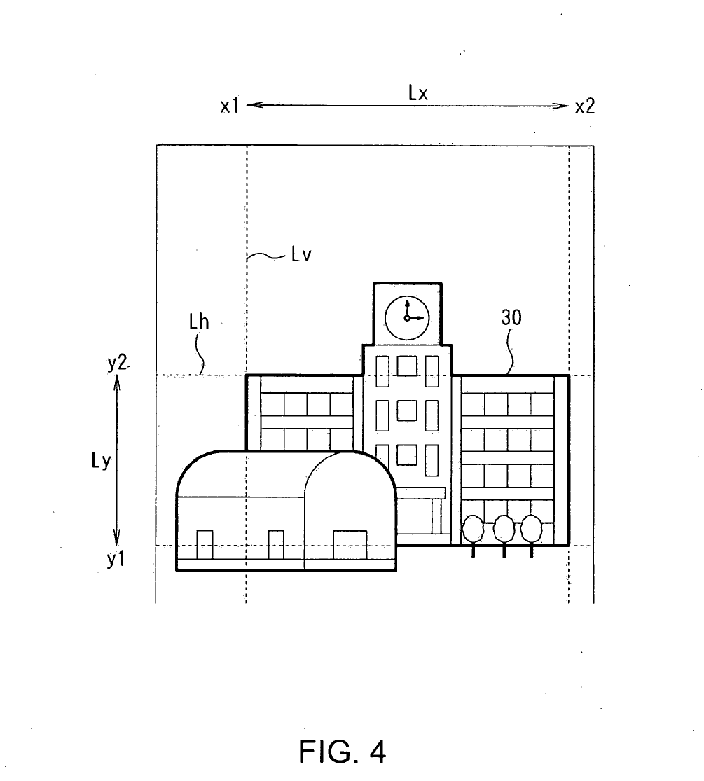

In other words, for example, by pressing the shutter button half a way down to measure the distance L in a state in which a building 30 shown in FIG. 4 is displayed on the finder display device 15 as the photographic subject, and then turning the measurement start/end switch 23 ON with the vertical line Lv of the cross cursor aligned with a left side wall of the building 30, and turning the measurement start/end switch 23 OFF with the vertical line Lv of the cross cursor aligned with a right side wall of the building 30 by turning the digital camera rightward, a width Lx between the both side walls of the building 30 can be measured.

In the same manner, by turning the measurement start/end switch 23 ON with the horizontal line Lh of the cross cursor aligned with a contact point of the building 30 with the ground, then turning the digital camera upward from this state to align the horizontal line Lh with a rooftop y2 of the building 30, and then turning the measurement start/end switch 23 OFF, a height Ly of the building 30 can be measured.

Therefore, since the width Lx and the height Ly of the building 30 can be measured, the surface area can be calculated on the basis of the width Lx and the height Ly.

In this manner, in the above-described embodiment, the distance between desired positions of the photographic object at a remote position can be measured with a simple operation such as aligning the cross cursor displayed on the finder display device 15 with the measurement start position and the measurement end position, turning the measurement start/end switch 23 ON at the measurement start position, and turning the measurement start/end switch 23 OFF at the measurement end position.

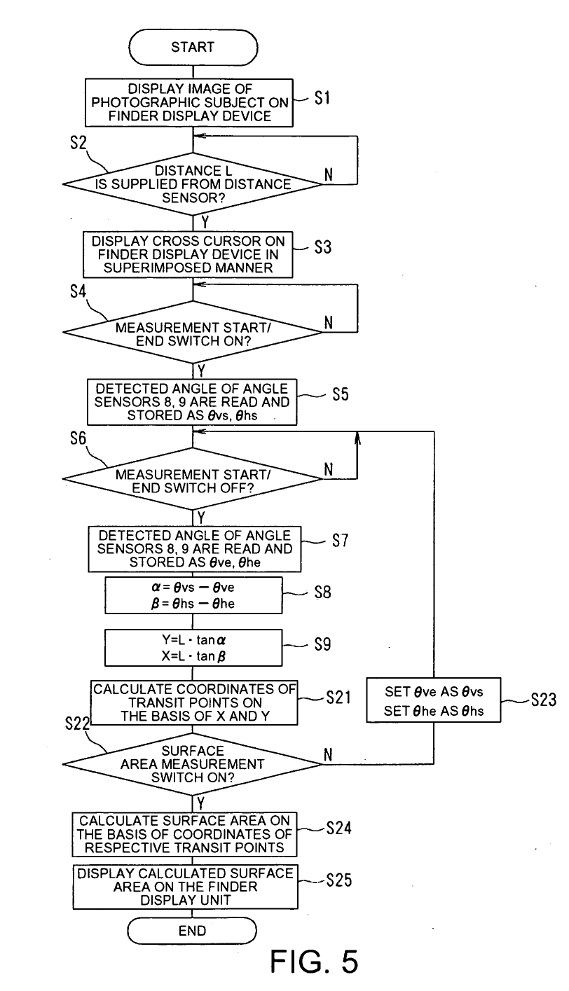

In the above-described embodiment, the case of measuring the linear distance between the measurement start position and the measurement end position of the photographic subject has been described. However, the invention is not limited thereto, and as shown in FIG. 5, it is also possible to configure as follows. Step S21 for calculating a transit coordinate on the basis of the calculated vertical actual distance Y and the horizontal actual distance X is inserted after Step S9 in the above-described process shown in FIG. 2, and Step S22 for determining whether or not a surface area measuring switch which is turned ON when it returns to the first measurement start point is in the ON state is inserted next to Step S21. Then Step S23 to be performed when the surface area measuring switch is in the OFF state is added. In Step S23, the detected angles θve and θhe read in Step S7 are stored as the measurement start angles θvs and θhs respectively and then the procedure goes to Step S6. When it is determined that the surface area measuring switch is ON as a result of determination in Step S22, the procedure goes to Step S24, where the surface area is calculated on the basis of the calculated transit coordinates. Subsequently, the procedure goes to Step S25, where the calculated surface is displayed on the finder display device 15 and end the process. In this case, the coordinates of the transit point on the contour of the photographic subject can be calculated in sequence by moving the cross cursor along the contour of the photographic subject with the measurement start/end switch 23 in ON state only at the beginning, and clicking the measurement start/end switch 23 at a desired transit point, and then the surface area of the range surrounded by the transit coordinates that indicates the contour can be calculated by turning the surface area measuring switch ON when returned to the original measurement start position. When the contour of the photographic subject is complex, the number of transit points may be increased and, for the linear portion, only the first and the last points are determined to be the transit points. In the process in FIG. 5, the processings in Step S4 to S9, S21 to S24 correspond to the actual surface area calculating means.

In the above-described embodiment, the case in which the distance sensor 22 that calculates the distance between the digital camera and the photographic subject by the incident angle of the reflected light of the infrared ray emitted from the infrared ray emitting unit 21 from the photographic subject is applied has been described. However, the invention is not limited thereto, and other distance sensors such as an ultrasonic distance sensor employing ultrasound or a laser beam distance sensor that detects reflected light of the laser beam may be optionally applied.

In the embodiment described above, the case in which the picked up image data is displayed on the finder display device 15 as display means, the invention is not limited thereto, and display may be made on other display units mounted to the digital camera.

In the above-described embodiment, the case in which the invention is applied to the digital camera has been described. However, the invention is not limited thereto, and may be applied to other arbitrary image pickup devices such as video camera, or a cellular phone provided with a TV camera.

The entire disclosure of Japanese Patent Application No. 2005-048640, filed Feb. 24, 2005 is expressly incorporated by reference herein.

What is claimed is:

1. An image pickup device comprising:
image pickup means that opposes correctly to a photographic subject, and forms and picks up an image of the same;
display means that displays an image data picked up by the image pickup means;
distance measuring means that measures a distance to the photographic subject to be picked up by the image pickup means;
index display means that displays an index on the display means so as to be superimposed on the image data;
angle of inclination measuring means that measures an angle of inclination of the image pickup means when it is inclined to align the index displayed by the index display means with a desired portion to be measured; and
actual dimension calculating means that calculates actual dimensions of an image of the photographic subject on the basis of a measurement of the distance measuring means and a measurement of the angle of inclination measuring means.

2. An image pickup device comprising:
image pickup means that opposes correctly to a photographic subject, and forms and picks up an image of the same;
display means that displays an image data picked up by the image pickup means;
distance measuring means that measures a distance to the photographic subject to be picked up by the image pickup means;
index display means that displays an index on the display means so as to be superimposed on the image data;
angle of inclination measuring means that measures an angle of inclination of the image pickup means when it is inclined to align the index displayed by the index display means with a desired portion to be measured; and
actual surface area calculating means that calculates actual surface area of an image of the photographic subject on the basis of a measurement of the distance measuring means and a measurement of the angle of inclination measuring means.

3. The image pickup device according to claim 1, wherein the index display means is configured to display a cross cursor on the display means so as to be superimposed on the image data.

4. The image pickup device according to claim 1, wherein the angle of inclination measuring means is a gyroscopic sensor for correcting camera shake.
